(19) United States
(12) Patent Application Publication
(10) Pub. No.: US 2012/0199525 A1
(43) Pub. Date: Aug. 9, 2012

(54) FILTRATION MEDIUM

(76) Inventor: Ross Leslie Palmer, Mt. Gravatt (AU)

(21) Appl. No.: 13/499,456

(22) PCT Filed: Oct. 4, 2010
(86) PCT No.: PCT/AU2010/001297

§ 371 Date: Apr. 27, 2012

(30) Foreign Application Priority Data
Oct. 2, 2009 (AU) 2009222556

(51) Int. Cl. B01D 39/06; B01D 15/00; B01D 35/02; B01D 27/02

(52) U.S. Cl. 210/200; 210/503; 210/282; 210/198.1

(57) ABSTRACT

A filtration medium comprises a first grade of glass particles and a material suitable to form a water permeable retention layer. Preferably, the filtration medium comprises at least two grades of glass particles. The first grade is preferably distributed substantially over the range of 0.75 mm to 1.7 mm. The second grade is preferably substantially in the range of 1.7 mm to 3 mm. In a further aspect, a filter is described having a water permeable retention layer supporting a filtration medium substantially comprising the first grade of particles. The retention layer may comprise the second grade of glass.

### FIELD OF THE INVENTION

The present invention relates to filtration media and a filtration assembly and system for bodies of water. The present invention particularly relates to a filtration medium, filter assembly and system for swimming pools, spas and the like.

### BACKGROUND OF THE INVENTION

The single largest surface area in a pool assembly may be the surface area of the filtration medium. Traditionally, sand has been used as a filtration medium for purposes such as filtering swimming pool water and the like. Sand however does have certain deficiencies which include a tendency to compaction and fissuring and a capacity to harbour bacteria algae and fungi.

Ground glass has been found to be of assistance in filtration media. Glass benefits from having a small particle size, bound silica content, non porous composition and cleanliness. Use of the glass types has advantages but also tends to suffer from a problem of poor filtering and, in general, has been used in large commercial installations, where coarse filtering is targeted. In these environments, pressure resistance, which occurs when a smaller grain size is used, is higher and filtration is obstructed or compromised.

### SUMMARY OF INVENTION

The present invention relates to a filtration medium for use in swimming pool, spas and the like, the filtration medium comprising glass particles.

In a first broad aspect, the invention may reside in a filtration medium for use with swimming pools and the like, the filtration medium comprising:

a) a first grade of glass particles substantially between 0.5 mm to 1.7 mm; and

b) a material suitable to form a water permeable, retention layer.

In a further aspect, the invention may reside in a filtration medium comprising at least two grades of glass, the first grade of glass (“Grade 1”) having particles substantially between 0.75 mm to 1.7 mm and a second grade of glass with particles substantially between 1.7 mm to 3 mm. The dimensions specified are fracture size as commonly determined by screening.

Preferably the first grade of glass has a percentage concentration substantially as follows:

| Fracture Size | Percentage of Volume |
|---|---|
| Greater than 1.7 mm | 0-7% Preferably 0-1% |
| 0.75 mm to 1.7 mm | 82.5-99% Preferably 92.5- |
| | 99% |
| Less than 0.75 mm | 0-15.5% Preferably 0-7.5% |

The second grade of glass (“Grade 2”) may comprise a percentage concentration substantially as follows:

| Fracture Size | Percentage of Volume |
|---|---|
| Greater than 3 mm | 0-5% preferably 0-3% most |
| | preferably 0-1% |
| 1.7 mm to 3 mm | 82.5-99% |
| | preferably 92.5-99% |
| Less than 1.7 mm | 0-7.5% |
| | preferably 0.1-3% |

The two grades of glass are preferably mixed in the ratio range of 1.0/1.0 Grade 1 to Grade 2 through to 3.0/1.0 Grade 1 to Grade 2.

In another aspect, the invention resides in a filter assembly for use for water filtration, the filter assembly comprising:
(a) a filter housing defining an internal space adapted for connection to a water circulation system;
(b) a filtration medium comprising a first grade of glass particles substantially in the range of 0.5 mm to 1.8 mm, the filtration medium in the internal space; and
(c) a water permeable, retention layer, said layer covering a water collecting arrangement.

Preferably the first grade of glass particles are in the range of 0.5 to 1.6 mm. The glass particles are most preferably less than 1.7 mm (diameter or fracture size) at least in a substantial proportion. The term “glass particles” in this specification should be understood to include fused silicon dioxide compounds. The filtration media or medium may include process activated metal fused silicon dioxide compounds and a filtration assembly and system for bodies of water.

The glass particles are preferably substantially in the range of 0.75 to 1.7 mm. The glass particles may be substantially in the range of 0.75 to 1.6 mm.

The water permeable retention layer may comprise a second layer of glass particles, preferably crushed glass particles, substantially in the size range of 1.5 to 3 mm. Preferably, the glass particles are substantially in the range of 1.7 mm to 3 mm in size. “Substantially in the range” in this case may be 8.25%-99% of the particles, preferably 92.5% to 99% of the particles.

The water permeable retention layer may comprise other suitable arrangements such as a mesh or series of meshes, a layer of pebbles (aggregate) or similar. Any material that is suitably inert but still allows water passage while retaining the filtration medium may be utilised.

The water collecting arrangement is preferably two or more water collecting tubes connected to a single outflow tube and preferably positioned at the bottom of the filter assembly.

The water filtration unit may be operatively connected to a water body, such as a swimming pool or spa, wherein said water body includes at least one hypohalous salt such as magnesium chloride for providing chemical treatment preferably by way of chlorination of the water body.

The preferred range of magnesium chloride is from 400 parts per million to 3000 parts per million.

In a further aspect the invention may reside in a water filtration system as described above, the system including a chlorinator adapted to provide chlorine from magnesium chloride or a similar salt.

In a further embodiment, the filtration system or filter assembly may include an activated compound positioned within the filter, the activated compound selected for removal of some of at least one undesirable compound.

The activated compound found preferably comprises zeolite. The activated compound could also comprise or include activated charcoal.

The activated compound is conveniently located inside a water permeable membrane. The water permeable membrane may be formed from nylon and may be formed as an elongate tubular structure.

The activated compound is preferably positioned adjacent a water inlet in the filter assembly, during filtration.

In yet another aspect, the invention may reside in a mixture of at least two glass filtration media, the glass filtration media as described above. The ratio of the first grade (“Grade 1”) to second grade (“Grade 2”) is preferably in the range of 1:1 to 3.5:1 including 1.5:1; to 3.0:1 and 2.0:1 to 2.5:1. The mixture may be packaged for supply to end-users in any suitable container. Such containers may include bags, boxes or sealed buckets.

### BRIEF DESCRIPTION OF THE FIGURES

FIG. 1 is a cross sectional view of a filtration assembly of the present invention.

FIG. 2 shows similar arrangement to FIG. 1 including an activated compound in the filtration assembly.

FIG. 3 shows an alternative filter arrangement.

FIG. 4 shows a schematic representation of a swimming pool filter system according to one aspect of the invention.

### DETAILED DESCRIPTION OF THE FIGURES

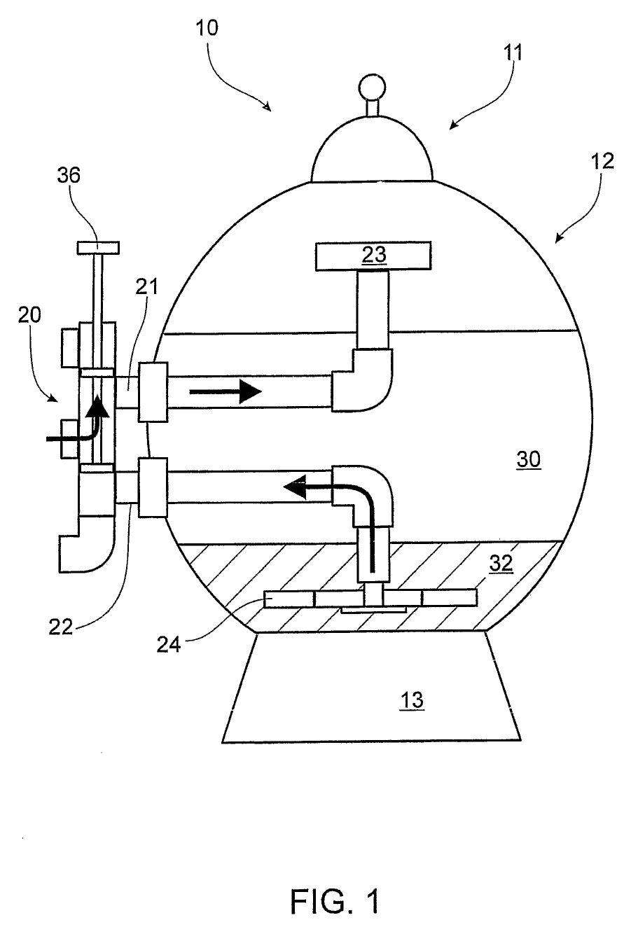

According to FIG. 1 there is seen a filter assembly 10, with an access hatch 11, a housing 12 and base 13. Visible components of a water circulation system 20 comprise an inlet pipe 21 and outlet pipe 22. The references to inlet and outlet refer to a normal filtering operation. If the filter assembly is operated in backwash mode, the directions would be reversed. The inlet pipe 21 terminates in distributor rose 23 which distributes pressurized water from the pool into filtration medium 30 within the housing 12. Water arriving has passed through the skimmer box and secondary filter before the fine filtration provided by the present filter assembly.

Water for filtration arrives under pressure and percolates through the filtration medium 30 before collection in collecting pipes 24, also often known as laterals, for the now filtered water to be passed through outlet pipe 22 and back to a pool or spa. One example of a water permeable retention layer 32 is shown. The water permeable retention layer comprises glass particles substantially in the range of 1.5 to 3 mm. An example of a suitable specification is set out in Table 1.

TABLE 1

| | |
|---|---|
| Fracture | Percentage of the Whole Volume |

| | | |
|---|---|---|
| 1.7 | mm | 0-7.5% |
| 3 | mm | 92.5-99% |
| >3 | mm | 0-1% |

It is understood that the particle size refers to a diameter for spherical particles or a maximal dimension for non spherical particles. A skilled person would also understand that the ranges provided refer to a substantial majority of the particles with the possibility of a small percentage of particles above or below the limits indicated.

In this case, the particles are mainly in the range of 1.7 mm to 3 mm.

The water permeable retention layer serves the purpose of supporting filtration medium 30. The preferred filtration medium is glass particles in the range of 0.5-1.8 mm. A particularly preferred specification of such glass particles is as follows in Table 2.

TABLE 2

| | |
|---|---|
| Fracture | Percentage of the Whole Volume |

| | | |
|---|---|---|
| 0.75 | mm | 0-7.5% |
| 1.7 | mm | 92.5-99% |
| >1.7 | mm | 0-1% |

Therefore the majority of particles are preferably in the range of 0.75 mm to 1.7 mm.

It should be understood that these ranges are exemplary in terms of the actual percentage components of different sizes and are simply indicative of the sizing process. However, the weighting provided is an indicator of the preferred range of components of such a glass mixture. The components may be used together in any suitable relative quantities. A preferred range is 1 to 1, filtration medium to water permeable layer through to 3.5 to 1, including 1.5 to 1, 2.0 to 1 and 2.5 to 1.

The inventor has surprisingly found that the two materials may be mixed together and introduced to a filter housing. After several backwashes, the materials appear to separate out into operative layers that largely reflect the different materials. The invention therefore extends to a mixture of two glass particle sizes, substantially as described herein and in the above ranges.

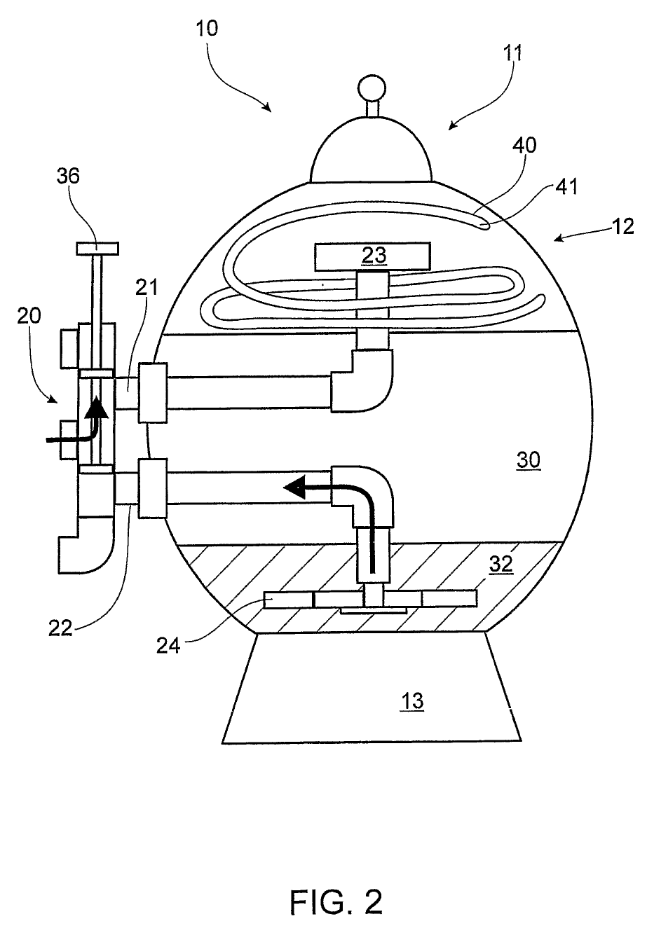

FIG. 2 is similar in arrangement and includes a nylon sock 40 as an example of a water permeable membrane. The sock is formed to define an internal tubular space which in this case is filled with zeolite 41 as an example of an activated compound.

The nylon sock 41 is formed as an elongate tubular structure with porosity sufficient to allow water to flow relatively freely through the structure. A particularly preferred activated compound is zeolite or an analogue thereof. The term “zeolite or analogue thereof” refers to materials, which due to their ion exchange capacity, micro porous nature or ion exchange capacity and micro porous nature are able to sequester certain molecular species from an environment. Of particular interest to the present invention is the ability of the material to sequester ammonium, ammonia or other like compounds from water. Zeolites are ideally suited to this task due to their high cation exchange capacity and micro porous structure. It will be appreciated however that other materials such as clays, clay like minerals, expandable clays, ion exchange resins, sulfate impregnated ceramics, chabizite, carbon (such as activated charcoal), or any other material which act as an ion exchange medium with ammonium could also be used in connection with the present invention. Zeolites are typically aluminosilicates which may be naturally occurring volcanic material or synthesized materials and have a three dimensional interconnecting ladder structure. Zeolites have the ability to adsorb, absorb and desorb specific molecules. One particular form of zeolite, clinoptililote, is known to have high selectivity for ammonia and may be a preferred form. However other zeolites, including synthetic zeolites may be used, as well as any suitable analogue. An additional advantage arises from the fact that zeolites are non toxic, and are therefore safe and do not pose health problems associated like other sequesters such as lime.

Given the advantage of the present applicant's magnesium chloride pool method, zeolites also have additional environmental advantage in that they are excellent agricultural fertilisation compounds. The exhausted material may therefore be safely exposed in the environment and may provide slow release potassium and nitrogen if loaded with ammonium.

While a sock has been described as a preferred water penetrable membrane, it is clear that other shapes and other materials will also serve the present purpose. For example, a bag structure may be formed or even a plastic mesh box which is dimensioned for loading into the filter arrangement.

The arrangement shown in FIGS. 1 and 2 also shows a novel arrangement of the inlet and outlet pipes of the water circulation system 20. A control valve is mounted at 36 such that delivery and outlet pipes are plumbed directly into the control valve, rather than describing a 90 degree (or thereabouts) bend. The provision of access hatch 11 is also a novel aspect made possible by the lateral inflow/outflow system.

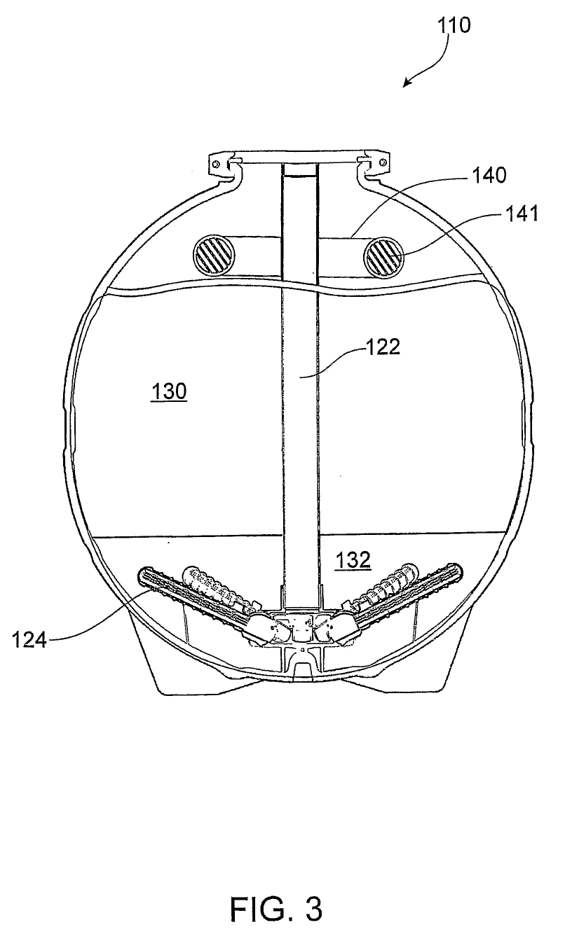

FIG. 3 is a cross sectional view of a conventional filter housing 110 with filtration medium 130 and retentional layer 132. The return or outlet pipe 122 is connected to laterals 124. The cylindrical, water permeable membrane 140 is of a more regular arrangement and located substantially horizontally. An active compound 141 is located in the cylindrical membrane 140.

The present applicant is the applicant for International Application PCT/AU2007/00893 for “IMPROVED WATER TREATMENT METHOD”. The disclosure is to a method of sanitation of water in a swimming pool of the like, to the contents of which are included herein by reference. The method comprises the steps of forming an electrolyte solution containing a range of soluble magnesium halide salt, and treating the electrolyte solution in an electrolytic halogenation cell to form an aqueous solution of hypohalus acid. The water is treated and returned to the pool. The inventor has surprisingly found that the use of the present filter assembly is particularly effective when used with the earlier method. Without being bound to any one theory, the applicant believes that its method of sanitization forms small flocculent aggregations (“flocs”). The use of the present invention provides a filtering mechanism which removes those flocs and provides a particularly clear and sanitized water body in a pool or similar.

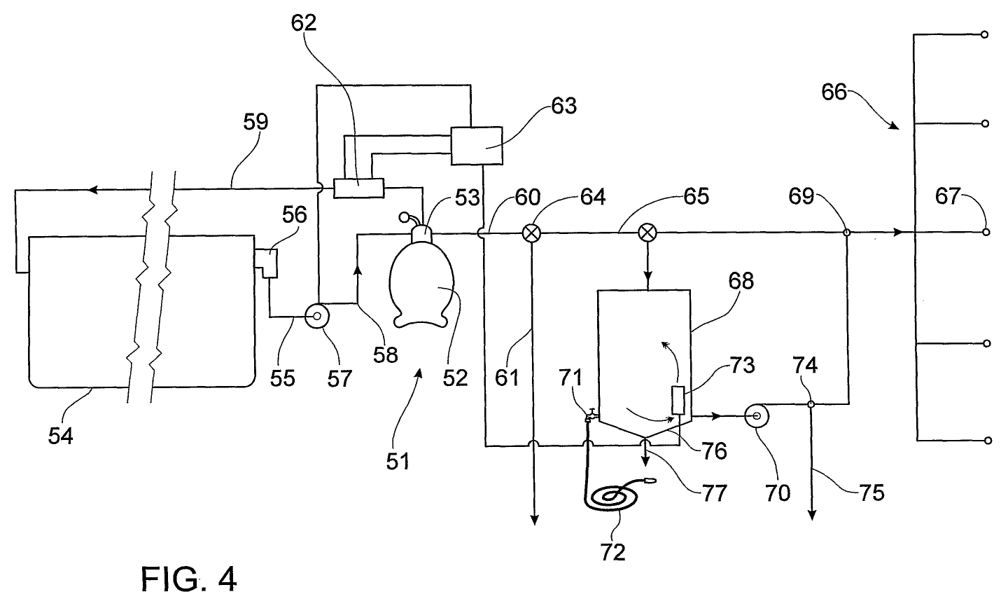

The invention therefore extends to an arrangement using the present filter assembly in a pool as shown in schematic form in FIG. 4. This figure shows a conventional swimming pool filtration system having an electrolytic or salt chlorinator. This arrangement also shows one system for conserving waste water from a swimming pool.

In a conventional swimming pool filtration system having an electrolytic or “salt” chlorinator, a filter system 51 comprising a filtration assembly 52 containing a filtration medium and a flow control valve 53 is coupled to a swimming pool 54 via a suction line 55 coupled at one end to a skimmer box 56 and at its other end to a filter pump 57. Pump 57, in turn, is coupled via conduit 58 to the control valve 53 which selectively diverts a flow of pressurized water into the filter body, to the return conduit 59 or through a bypass circuit in the valve 53 back to return conduit 59. The valve 53 also permits water to be directed via backwash and rinse settings to a waste conduit 60 coupled to a conduit 61 coupled to a storm water drain or a sewer line as required by local government regulation.

Also coupled into the return conduit 69 is an electrolytic chlorinator 62 electrically coupled to a controller 63 which, in turn, is electrically coupled to filter pump 57.

In the embodiment illustrated, waste conduit 60 may be disconnected from a storm water drain and/or a bypass valve 64 installed. Conduit 60 is then connected directly or via bypass valve 64 to an irrigation feed conduit 65 coupled to an irrigation reticulation system 66 having a plurality of sprinkler or dripper heads 67. During a backwash, rinse or bypass cycle, water which might otherwise be wasted is directed at filter pump pressure and flow rates to the reticulation system 66 designed to accommodate such pressures and flow rates.

In an alternative embodiment, where local government authorities so permit, the backwash, rinse and overflow waters may be accumulated in a below ground or above ground storage tank 68 of a suitable capacity for irrigation under controlled conditions. The stored water in tank 68 may be allowed to flow to irrigation reticulation system 66 under the influence of gravity via a manual flow control valve 69 or alternatively, a water pump 70 of suitable capacity may be employed to deliver irrigation water against a head pressure at a predetermined rate to garden plants, lawns and the like.

If required, stored backwash/rinse water may be drawn from tank 68 via a tap 71 to a bucket or watering can or, via tap 71 through a garden hose 72 for direct application to lawns or garden beds.

In other embodiments, collection tank 68 may have a tapered floor 76 forming a sediment collection sump and an outlet valve 77 is provided to enable periodic disposal of sediment collected in the bottom of the tank. The supernatant liquid can then be utilized on a garden or the like or, after sterilization, by a further electrolytic chlorinator 73 the sterilized water may be redirected back to the swimming pool. Alternatively, tank 68 may be positioned between filter pump 57 and filtration system 52 to function as a settling tank to remove at least part of the suspended solids before filtration in system 52.

Compared with conventional silicious filtration media, amorphous silica containing filtration media such as the present glass have a reduced risk of cementing together as a solid mass. Heavy metals and dissolved organics may be removed by surface attraction.

Still further comparative beneficial properties claimed may include:—

surface catalytic properties make the media inhibit bacterial multiplication;

does not become blocked by bacterial growth in the filter bed;

easier to backwash requiring less pump energy and up to 50% less water;

filtration medium has a very high attrition strength leading to reduced media loss;

smooth, non-porous structure leading to reduced harbouring of micro-organisms;

By utilizing process activated metallic fused silicon dioxide compounds in conjunction with the chlorine containing electrolytes according to the invention, it is believed that the quality of water directed to waste from backwashing, rinsing or filter bypass to reduce swimming pool levels will be substantially less harmful to the environment when directed though a storm water drain or less harmful to process systems for sewer waste. Moreover, the reduction in pathogenic contamination of swimming pool waste waters can permit the direct application of waste water, collected in storage tank 68 to be used directly on lawns or gardens without the attendant risks normally associated with silica sand or zeolite filter media or even grey water application to domestic lawns and gardens.

The present size solution is particularly effective while at the same time reducing back pressure. In backwashing, particles appear to be readily lifted from the medium and discharged to waste, again enhancing water conservation.

The expressions “swimming pool” and “swimming pools and the like” should be understood as extending to spas.

Throughout the specification the aim has been to describe the preferred embodiments of the invention without limiting the invention to any one embodiment or specific collection of features. It will therefore be appreciated by those of skill in the art that, in light of the instant disclosure, various modifications and changes can be made in the particular embodiments exemplified without departing from the scope of the present invention.

1. A filtration medium for use with swimming pools and the like, the filtration medium comprising at least two grades of glass particles, the first grade substantially between 0.75 mm to 1.7 mm in size and a second grade with particles substantially in a range of 1.7 mm to 3 mm.

2. The filtration medium of claim 1 wherein the first grade of glass has a percentage concentration of sizes with 0-7% greater than 1.7 mm, 82.5-99% with sizes in a range of 0.75 mm to 1.7 mm and 0-15.5% less than 0.75 mm.

3. The filtration medium of claim 2 wherein the percentage concentration of particle sizes of the first grade of glass is 0-1% greater than 1.7 mm, 92.5-99% in a range of 0.75 mm to 1.7 mm and 0-7.5% less than 0.75 mm.

4. The filtration medium of claim 1 wherein the second grade of glass comprises a percentage concentration of particles of 0-5% greater than 3 mm, 82.5-99% in a range of 1.7 mm to 3 mm and 0-7.5%, less than 1.7 mm.

5. The filtration medium of claim 4 wherein the size range of particles in the second grade of glass particles is 0.1-3% greater than 3 mm, 92.5-99% in the range of 1.7 mm to 3 mm and 1-3% less than 1.7 mm.

6. The filtration medium of claim 4 wherein the size range of particles in the second grade of glass particles is 0-1% greater than 3 mm, 92.5-99% in the range of 1.7 mm to 3 mm and 0-7.5% less than 1.7 mm.

7. The filtration medium of claim 1 wherein the ratio of the quantity of the first grade to the second grade is in the range of 1:1 to 3.5:1.

8. The filtration medium of claim 7 wherein the ratio is in the range of 1.5:1 to 3.0:1.

9. A filter assembly for use for water filtration, the filter assembly comprising:
(a) a filter housing defining an internal space and adapted for connection to a water circulation system;
(b) a filtration medium comprising glass particles substantially in a range of 0.5 mm to 1.8 mm, the filtration medium in the internal space; and
(c) a water permeable, retention layer, said layer covering a water collecting arrangement.

10. The filter assembly of claim 9 wherein the glass particles are substantially in the range of 0.5 to 1.6 mm.

11. The filter assembly of claim 10 wherein the glass particles are substantially in a range of 0.75 to 1.6 mm.

12. The filter assembly of claim 9 wherein the water permeable retention layer comprises a second layer of glass particles substantially in a size range of 1.5 mm to 3 mm.

13. The filter assembly of claim 9 wherein the water permeable retention layer comprises a layer of pebbles.

14. The filter assembly of claim 9 wherein the water permeable retention layer comprises a mesh or series of meshes adapted to retain the filtration medium above the water collecting arrangement.

15. The filter assembly of claim 9 wherein the water collecting arrangement is two or more water collecting tubes connecting to a single outlet tube, the collecting tubes positioned at or towards a bottom of the filter assembly.

16. A water filtration system including the filter assembly of claim 9 operably connected to a water body wherein said water body includes a hypohalous salt for providing chemical treatment of the water body.

17. The water filtration system of claim 16 wherein the salt is magnesium chloride.

18. The water filtration system of claim 17 wherein magnesium chloride is present in the range of 400 parts per million to 3000 parts per million.

19. The water filtration system of claim 16 further comprising an activated compound positioned within or in liquid communication with the filter, the activated compound selected for removal of some of at least one undesirable compound.

20. The filtration system or filter assembly of claim 19 wherein the activated compound comprises or includes zeolite.

21. The filtration system or filter assembly of claim 19 wherein the activated compound comprises or includes activated charcoal.

22. The filtration system or filter assembly of claim 19 wherein the activated compound is located inside a water permeable membrane.

23. The filtration system or filter assembly of claim 22 wherein the water permeable membrane is formed from nylon.

24. The filtration system or filter assembly of claim 23 wherein the water permeable membrane is formed as an elongate tubular structure.

25. The filtration medium of claim 1 when packaged for supply to end users.

26. The filter assembly of claim 8 further comprising an activated compound positioned within or in liquid communication with the filter, the activated compound selected for removal of some of at least one undesirable compound.

27. The filtration system or filter assembly of claim 26 wherein the activated compound comprises or includes zeolite.

28. The filtration system or filter assembly of claim 26 wherein the activated compound comprises or includes activated charcoal.

29. The filtration system or filter assembly of claim 26 wherein the activated compound is located inside a water permeable membrane.

30. The filtration system or filter assembly of claim 29 wherein the water permeable membrane is formed from nylon.

31. The filtration system or filter assembly of claim 30 wherein the water permeable membrane is formed as an elongate tubular structure.
